(19) United States
(12) Patent Application Publication
(10) Pub. No.: US 2012/0177869 A1
(43) Pub. Date: Jul. 12, 2012

(54) FLEXIBLE CORE AND RIGID BACKED SUPPORT LAYER ARMOR COMPOSITE

(76) Inventor: Jamin Micarelli, Kirkland, WA (US)

(21) Appl. No.: 12/429,124

(22) Filed: Apr. 23, 2009

Related U.S. Application Data
(60) Provisional application No. 61/047,359, filed on Apr. 23, 2008.
(60) Provisional application No. 61/047,364, filed on Apr. 23, 2008.
(60) Provisional application No. 61/047,369, filed on Apr. 23, 2008.
(60) Provisional application No. 61/047,410, filed on Apr. 23, 2008.
(60) Provisional application No. 61/095,957, filed on Sep. 11, 2008.
(60) Provisional application No. 61/146,077, filed on Jan. 21, 2009.
(60) Provisional application No. 61/155,609, filed on Feb. 26, 2009.
(60) Provisional application No. 61/172,065, filed on Apr. 23, 2009.

(51) Int. Cl. B32B 5/12; B32B 7/02

(52) U.S. Cl. 428/105; 428/212

(57) ABSTRACT

An armor composite is disclosed having a relatively rigid backed support layer and a relatively softer, flexible core, with the flexible core serving as the impact layer for a projectile. In some embodiments, the flexible core is composed of two or more fibrous thermoplastic layers forcibly combined using heat and pressure.

A method for making armor is disclosed that has the steps of providing one or more fiber and thermoplastic layers, gelling the layers, degassing the layers, applying isostatic pressure to the layers, and solidifying the consolidated layer under isostatic pressure to provide a rigid backed support layer.

This application claims the benefit of U.S. Provisional Patent Applications 61/047,359 filed Apr. 23, 2008; 61/047,364 filed Apr. 23, 2008; Application 61/047,369 filed Apr. 23, 2008: 61/047,410 filed Apr. 23, 2008; 61/095,957 filed Sep. 11, 2008; 61/155,609 filed Feb. 26, 2009; 61/146,077 filed Jan. 21, 2009; and 61/172,065 filed Apr. 23, 2009. In addition, This application also claims the benefit of U.S. patent application Ser. No. 12/401,582 filed Mar. 10, 2009 which claimed priority to U.S. Provisional Patent Application 61/068,964 filed Mar. 10, 2008. The foregoing applications are hereby incorporated by reference in their entirety as if fully set forth herein.

### TECHNICAL FIELD

This invention relates generally to ballistics, and more specifically, to systems and methods for providing a flexible core and rigid backed support layer armor composite.

### BACKGROUND OF THE INVENTION

In a typical armor composition, the impact layer of the armor is the hardest having low elongation and low plasticity. This is compared to the underlying support layer which is stronger and has greater elongation and plasticity properties. Thus, in the typical armor composition, the impact layer is configured to break up a projectile and the support layer is configured to catch the remnants of the projectile.

Unfortunately, typical armor compositions are unable to withstand multiple rounds without major back face deformation at a weight that is low enough to be usable. For example, the average weight of level 3a armor is 1 lbs per square foot. When such armor is impacted with a 240 g .44 mag jacketed soft point at 1460 fps, it results in average back face into regulation clay of approximately 40 to 60 mm. This means that being shot while wearing a close fitting helmet of such armor would pose a significant risk of injury or death.

### DISCLOSURE OF THE INVENTION

This invention relates generally to ballistics, and more specifically, to systems and methods for providing a flexible core and rigid backed support layer armor composite. In some embodiments, the invention includes an armor composite having a rigid backed support layer and a flexible core, wherein the flexible core is configured as an impact layer for a projectile.

In some embodiments, the rigid backed support layer is composed of one or more fiber and thermoplastic layers, the one or more thermoplastic layers being forcibly infiltrated through the one or more fiber layers using heat and omni-directional pressure, with the forcibly infiltrated thermoplastic being cooled under omni-directional pressure.

In some embodiments, the one or more fiber comprises KEVLAR and the one or more thermoplastic comprises polycarbonate. In some embodiments, the flexible core is composed of two or more fibrous thermoplastic layers, the two or more fibrous thermoplastic layers being forcibly combined using heat and omni-directional pressure, and the forcibly combined thermoplastic being cooled under omni-directional pressure. In some embodiments, the two or more fibrous thermoplastic layers comprise unidirectional SPECTRA SHIELD 3124 by Allied Signal that are crosspliedly stacked. In some embodiments, the armor composite is associated with a vehicle, a boat, a plane, a helicopter, a wall, a floor, a ceiling, a structure, a helmet, a shield, a vest, or a body armor.

### BRIEF DESCRIPTION OF THE DRAWINGS

FIG. 1 is a flow diagram for a method of manufacturing a flexible core and rigid backed support layer armor composite, in accordance with an embodiment of the invention;

FIG. 2 is a flow diagram for a method of manufacturing a rigid backed support layer, in accordance with an embodiment of the invention;

FIG. 3 is a flow diagram for a method of manufacturing a flexible core, in accordance with an embodiment of the invention;

FIG. 4 illustrates layers for constructing a rigid backed support layer, in accordance with an embodiment of the invention;

FIG. 5 illustrates layers for constructing a flexible core, in accordance with an embodiment of the invention;

FIG. 6 illustrates a flexible core and a rigid backed support layer, in accordance with an embodiment of the invention;

FIG. 7 illustrates a helmet constructed from a flexible core and a rigid backed support layer, in accordance with an embodiment of the invention;

FIG. 8 illustrates a vest constructed from a flexible core and a rigid backed support layer, in accordance with an embodiment of the invention; and

FIGS. 9-10 illustrate a flexible core and a rigid backed support layer, in accordance with an embodiment of the invention.

FIGS. 11-13 illustrate particular ballistic performance characteristics of preferred armor composite embodiments.

### BEST MODE OF CARRYING OUT THE INVENTION

Turning now to the drawings, the invention will be described in a preferred embodiment by reference to the numerals of the drawing figures wherein like numbers indicate like parts.

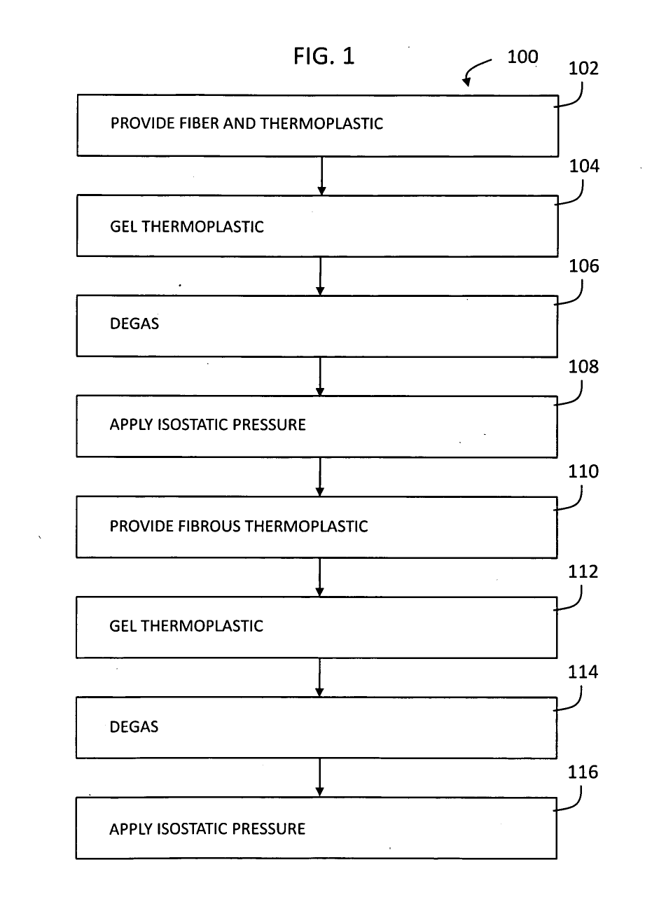

This invention relates generally to ballistics, and more specifically, to systems and methods for providing a flexible core and rigid backed armor composite. Specific details of certain embodiments of the invention are set forth in the following description and in FIGS. 1-8 to provide a thorough understanding of such embodiments. The present invention may have additional embodiments, maybe practiced without one or more of the details described for any particular described embodiment, or may have any detail described for one particular embodiment practiced with any other detail described for another embodiment.

FIG. 1 is a flow diagram for a method of manufacturing a flexible core and rigid backed support layer armor composite, in accordance with an embodiment of the invention. In one embodiment, method 100 comprises the steps of providing one or more fiber and thermoplastic layers at 102, gelling the thermoplastic at 104, degassing at 106, applying isostatic pressure at 108, adding fibrous thermoplastic at 110, gelling the thermoplastic at 112, degassing at 114, and applying isostatic pressure at 116.

In some embodiments, the providing one or more fiber and thermoplastic layers at 102 includes stacking two or more fiber layers with at least one thermoplastic layer interposed on or between the two or more fiber layers. In some embodiments, the providing one or more fiber and thermoplastic layers at 102 includes stacking two or more fiber layers and spraying at least some thermoplastic on or between the two or more fiber layers. In some embodiments, the providing one or more fiber and thermoplastic layers at 102 includes stacking two or more fiber layers and disposing at least some granular thermoplastic on or between the two or more fiber layers. In some embodiments, the two or more fiber layers are disposed with fibers aligned in parallel, perpendicularly aligned, obliquely aligned, or otherwise aligned. In some embodiments, the two or more fiber layers are composed of one or more different or additional materials. In some embodiments, the thermoplastic is composed of one or more different or additional materials. In some embodiments, adhesive or bonding agents are further provided with the one or more fiber and thermoplastic layers. In some embodiments, no additional adhesive or bonding agents are provided with the one or more fiber and thermoplastic layers.

In some embodiments, the fiber layer includes KEVLAR, a non-impregnated ballistic cloth, a polyethylene based material, a high density/molecular weight polyethylene based material, an ultra-high density/molecular weight polyethylene based material, a polypropylene based material, a ceramic based material, an aramid based material, a PBO based material, a liquid crystal polymer based material, a carbon based material, a material having woven fibers, a high modulus vinylon based material, a boron carbide based material, an alumina oxide based material, a silicon carbide based material, a glass based material, a reinforced aluminum based material, another fibrous material, SPECTRA SHIELD by Honeywell, DYNEMA by DSM, GOLD FLEX or GOLD SHIELD by Honeywell, material described in U.S. Pat. No. 5,330,820, material described in U.S. Pat. No. 5,443,882, material described in U.S. Pat. No. 7,148, 162, material described in U.S. Pat. No. 7,073,538, all of which are hereby incorporated by reference in their entirety as if fully set forth herein. The fiber layer can have tows that arc unidirectional, woven, or multidirectional.

In some embodiments, the fiber layer is composed of two or more unidirectionally-oriented fiber bundles that are each carried on a fiber-stabilizing heat-activatable scrim. The two or more unidirectionally-oriented fiber bundles are crosspliedly layered and thermally bonded together through heat activation of the scrims.

In some embodiments, the fiber layer is composed of two or more unidirectionally-oriented fiber bundles that are each sandwiched between fiber-stabilizing heat-activatable scrims. The two or more unidirectionally-oriented fiber bundles are crosspliedly layered and thermally bonded together through heat activation of the scrims.

In some embodiments, the fiber layer is composed of a first set of continuous filament unidirectional fibers lying in a first plane and a second set of continuous filament unidirectional fibers lying in a second plane. The first and second sets of filament unidirectional fibers are transversely layered and a third set of fibers are interlaced with the first and second sets of fibers to form interlocking loops. In some embodiments, the fibers of the first and second set have tenacities equal to or greater than about 15 g/d, initial tensile moduli equal to or greater than about 400 g/d, and energies-to-break equal to or greater than about 22 J/g, as measured by ASTM D2256. In some embodiments, the fibers of the first and second set have at least twice the breaking strength and one-half the elongation-to-break as compared to the fibers of the third set.

In some embodiments, the thermoplastic layer includes a polycarbonate based material, a polyester based material, a polyurethane based material, an epoxy based material, a rubber based material, a resin, or some other similar material. In some embodiments, the thermoplastic layer is thermosetting, thermocuring, or ultraviolet curing. In some embodiments, the thermoplastic layer is sprayable. In some embodiments, the thermoplastic layer is granular.

In some embodiments, the gelling the thermoplastic at 104 includes heating the one or more fiber and thermoplastic layers to a temperature at or above the thermoplastic melting point. In some embodiments, gelling as used herein is intended to mean heating to just above a glass transition temperature. In some embodiments, the gelling the thermoplastic at 104 includes applying at least some pressure. The one or more fiber and thermoplastic layers can be formed to a desired shape or mold while the thermoplastic is gelled. In some embodiments, the gelling the thermoplastic at 104 is performed using a hot isostatic press as disclosed in U.S. Provisional Patent Application 61/068,964 and Ser. No. 12/401,582.

In some embodiments, the degassing at 106 includes applying a vacuum source to the one or more fiber and thermoplastic layers while the thermoplastic is gelled to remove at least some gas. In some embodiments, the degassing at 106 includes slightly decreasing the temperature from that applied at 104. In some embodiments, the degassing at 106 includes applying at least some pressure. In some embodiments, the degassing at 106 is performed using a hot isostatic press as disclosed in U.S. Provisional Patent Application 61/068,964 and Ser. No. 12/401,582.

In some embodiments, the applying isostatic pressure at 108 includes applying high amounts of omni-directional pressure to the one or more fiber and thermoplastic layers while the thermoplastic is gelled in order to forcibly infiltrate the thermoplastic through, between, and around fibers of the one or more fiber layers. Omni-directional pressure as used herein is intended to mean substantially similar pressure from substantially all directions. In some embodiments, non-omni-directional pressure is applied. In some embodiments, the applying isostatic pressure at 108 includes slightly decreasing the temperature from that applied at 104 or 106. In some embodiments, after infiltration of the thermoplastic, the applying isostatic pressure at 108 includes reducing the temperature below the thermoplastic melting point while under omni-directional pressure. In some embodiments, after reducing the temperature below the thermoplastic melting point, the applying isostatic pressure at 108 includes reducing the omni-directional pressure. In some embodiments, the applying isostatic pressure at 108 is performed using a hot isostatic press as disclosed in U.S. Provisional Patent Application 61/068,964 and Ser. No. 12/401,582.

In some embodiments, the composite resulting from 108 provides a rigid backed support layer for use in armor. Many variations can be made with the materials, relative amounts of materials, temperatures, pressure amounts, pressure directions, vacuum source amounts, and timing to provide for various rigid backed support layer characteristics. For example, in some embodiments the rigid backed support layer can be rated between Shore D 50* and Rockwell R 150* according to ASTM test standards.

In some embodiments, the providing fibrous thermoplastic at 110 includes stacking two or more fibrous thermoplastic layers on the rigid backed support layer from 108. In some embodiments, the two or more fibrous thermoplastic layers are disposed with fibers aligned in parallel, perpendicularly aligned, obliquely aligned, or otherwise aligned. In some embodiments, the two or more fibrous thermoplastic layers are composed of one or more different or additional materials. In some embodiments, the fibrous thermoplastic includes fibrous polyethylene such as Honeywell SPECTRA 3124, a material disclosed supra at 102, or another similar material.

In some embodiments, the gelling the thermoplastic at 112 includes heating the two or more fibrous thermoplastic layers from 110 to a temperature at or above the thermoplastic melting point without gelling the thermoplastic within the rigid backed support layer. In some embodiments, the gelling the thermoplastic at 112 includes applying at least some pressure. In some embodiments, the gelling the thermoplastic at 112 is performed using a hot isostatic press as disclosed in U.S. Provisional Patent Application 61/068,964 and Ser. No. 12/401,582.

In some embodiments, the degassing at 114 includes applying a vacuum source to the two or more fibrous thermoplastic layers from 112 while the thermoplastic of the two or more fibrous thermoplastic layers is gelled to remove at least some gas. In some embodiments, the degassing at 114 includes applying at least some pressure. In some embodiments, the degassing at 114 is performed using a hot isostatic press as disclosed in U.S. Provisional Patent Application 61/068,964 and Ser. No. 12/401,582.

In some embodiments, the applying isostatic pressure at 116 includes applying high amounts of omni-directional pressure to the two or more fibrous thermoplastic layers while the thermoplastic is gelled in order to combine the two or more fibrous thermoplastic layers into a flexible core. In some embodiments, non-omni-directional pressure is applied. In some embodiments, after the two or more fibrous thermoplastic layers are combined into the flexible core, the applying isostatic pressure at 116 includes reducing the temperature below the thermoplastic melting point of the two or more fibrous thermoplastic layers while under omni-directional pressure. In some embodiments, after reducing the temperature below the thermoplastic melting point of the two or more fibrous thermoplastic layers, the applying isostatic pressure at 116 includes reducing the omni-directional pressure. In some embodiments, the applying isostatic pressure at 116 is performed using a hot isostatic press as disclosed in U.S. Provisional Patent Application 61/068,964 and Ser. No. 12/401,582.

In some embodiments, the composite resulting from 116 provides a flexible core and rigid backed support layer for use in armor or as a safety material to protect against fragments, blunt impact, or other high energy projectiles. The rigid backed support layer provides high compressive properties that transfer through the flexible core during ballistic impact. Accordingly, a bullet can be captured in the flexible core and the energy can be absorbed by the rigid backed support layer. Due to the support provided by the rigid backed support layer, the compression strength of the flexible core is increased, causing a projectile to deform and spread out its mass thereby reducing its penetration. In some embodiments, a flexible core and rigid backed support layer having a weight of 1.1 lbs per square foot can be impacted by a 240 g .44 mag jacketed soft point at 1460 fps and result in back face of only around 1-2 mm. Further, such flexible core and rigid backed support layer can sustain multiple impacts without significant deterioration.

In some embodiments, method 100 further includes providing a protective shell finishing for the flexible core and rigid backed support layer. In some embodiments, the protective shell finishing is composed of carbon fiber and KEVLAR in a polypropylene resin. However, the protective shell finishing may be constructed from any material referenced herein or other material to provide wear and tear protection or additional ballistic protection. For example, in some embodiments, the protective shell finishing can be composed of the same or different material present in the rigid backed support layer or the flexible core. In some embodiments, the protective shell finishing is omitted.

Many variations can be made with the materials, relative amounts of materials, temperatures, pressure amounts, pressure directions, vacuum source amounts, and timing to provide for various flexible core and rigid backed support layer characteristics. For example, in some embodiments the flexible core can be rated between shore A 0* and shore A 95* according to ASTM test standards. Additionally, in some embodiments, the rigid backed support layer can be substituted or complimented with titanium, aluminum, or some other similar material.

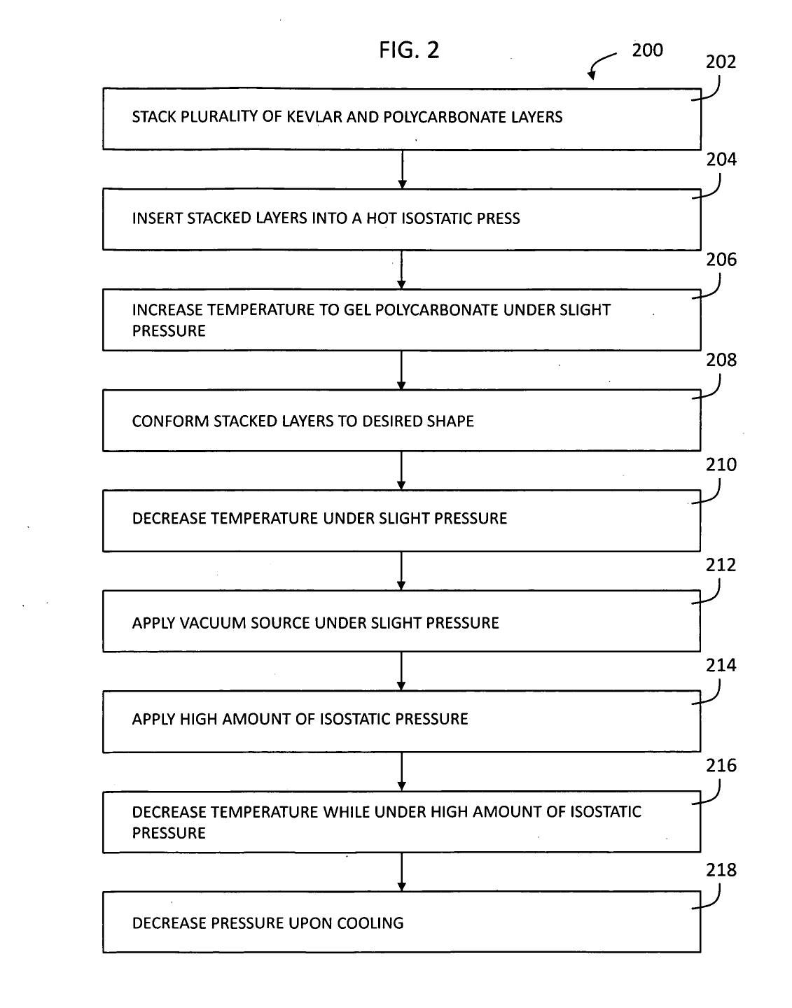

FIG. 2 is a flow diagram for a method of manufacturing a rigid backed support layer, in accordance with an embodiment of the invention. In one embodiment, method 200 comprises the steps of stacking a plurality of KEVLAR and polycarbonate layers at 202, inserting the stacked layers into a hot isostatic press at 204, increasing the temperature to gel the polycarbonate under slight pressure at 206, conforming the stacked layers to a desired shape at block 208, slightly decreasing the temperature under slight pressure at 210, applying a vacuum source under slight pressure at 212, applying a high amount of isostatic pressure at 214, decreasing the temperature while under a high amount of isostatic pressure at 216, and decreasing the pressure upon cooling at block 218.

In some embodiments, the stacking a plurality of KEVLAR and polycarbonate layers at 202 includes stacking 11 layers of woven KEVLAR 29 3000 denier 21×21″ with 7 layers of 0.005″ thick polycarbonate sheets with the polycarbonate sheets interposed with the KEVLAR. In some embodiments, the stacked KEVLAR and polycarbonate sheets are disposed in a sealed vacuum bag that is capable of withstanding high temperatures (e.g., 600 F), the vacuum bag having a vacuum port. In some embodiments, the vacuum bag is omitted. In some embodiments, sufficient polycarbonate is provided to wet the KEVLAR during the following method steps without leaving any dry spots. In some embodiments, different materials are used and/or different relative amounts of the materials are used.

In some embodiment, the inserting the stacked layers into a hot isostatic press at 204 includes disposing the stacked KEVLAR and polycarbonate sheets into a hot isostatic press as disclosed in U.S. Provisional Patent Application 61/068,964 and Ser. No. 12/401,582. Other presses are employable with method 200, including those that are not isostatic.

In some embodiments, the increasing the temperature to gel the polycarbonate under slight pressure includes increasing the temperature to approximately 450 F under approximately 200 PSI. In some embodiments, greater or less temperature and/or pressure are employed.

In some embodiments, the conforming the stacked layers to a desired shape at 208 includes conforming the stacked layers to a mold such as for a helmet, vehicle component, vest, shield, body armor, or other similar article while the polycarbonate is gelled. In some embodiments, the conforming the stacked layers to a desired shape at 208 is omitted.

In some embodiments, the decreasing the temperature under slight pressure at 210 includes decreasing the temperature to approximately 390 F under approximately 200 PSI using a hot isostatic press as disclosed in U.S. Provisional Patent Application 61/068,964 and Ser. No. 12/401,582. In some embodiments, greater or less temperature and/or pressure are employed. In some embodiments, the decreasing the temperature under slight pressure at 210 is omitted.

In some embodiments, the applying a vacuum source under slight pressure at 212 includes applying a vacuum source for approximately 5 minutes at approximately 350 F under approximately 200 PSI using a hot isostatic press as disclosed in U.S. Provisional Patent Application 61/068,964 and Ser. No. 12/401,582 to de-gas the stacked layers. In some embodiments, the vacuum source is applied using the vacuum bag having a vacuum port.

In some embodiments, the applying a high amount of isostatic pressure at 214 includes applying omni-directional pressure of approximately 2500-3000 PSI at approximately 350 F for approximately 25 minutes using a hot isostatic press as disclosed in U.S. Provisional Patent Application 61/068,964 and Ser. No. 12/401,582 to infiltrate polycarbonate between, around, and through fibers of the KEVLAR. In some embodiments, greater or less temperature, time, and/or pressure are employed. In some embodiments, non-omni-directional pressure is applied.

In some embodiments, the decreasing the temperature while under a high amount of isostatic pressure at 216 includes decreasing the temperature to approximately 100 F while under omni-directional pressure of approximately 2500-3000 PSI to freeze the polycarbonate in place between, around, and through fibers of the KEVLAR. In some embodiments, the decreasing the temperature while under a high amount of isostatic pressure at 216 is accomplished by running cold water through cooling tubes for approximately 20 minutes until a temperature of approximately 100 F is reached while maintaining omni-directional pressure of approximately 2500-3000 PSI.

In some embodiments, the decreasing the pressure upon cooling at 218 includes reducing the pressure to establish the rigid backed support layer.

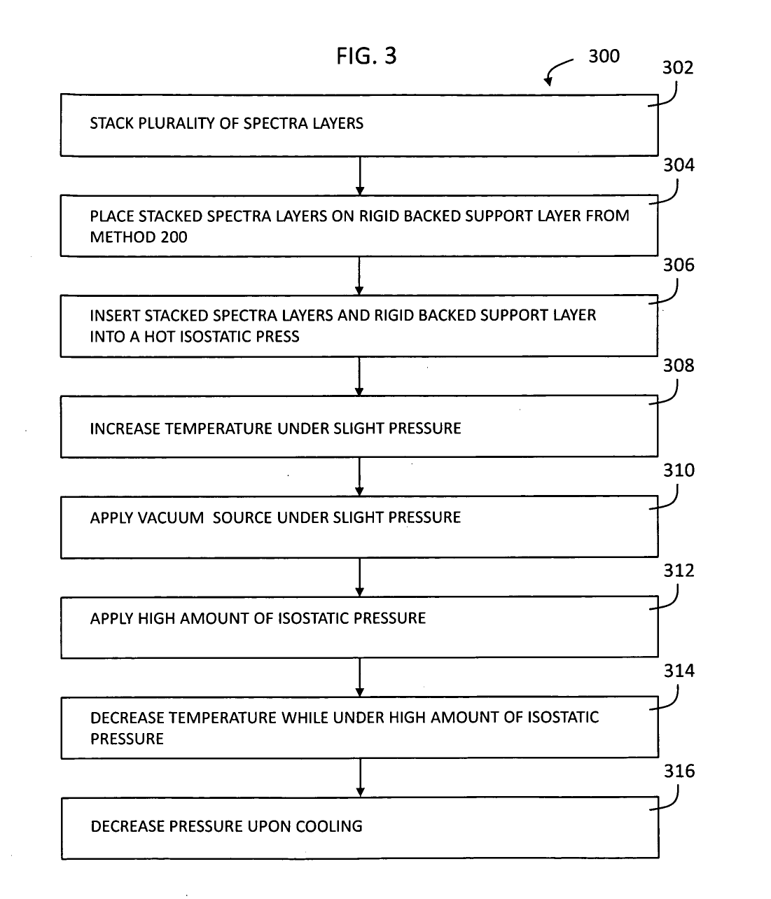

FIG. 3 is a flow diagram for a method of manufacturing a flexible core, in accordance with an embodiment of the invention. In one embodiment, method 300 includes stacking a plurality of SPECTRA layers at 302, placing the stacked SPECTRA layers on the rigid backed support layer from 200 at 304, inserting the stacked SPECTRA layers and rigid backed support layer into a hot isostatic press at 306, increasing the temperature under slight pressure at 308, applying a vacuum source under slight pressure at 310, applying a high amount of isostatic pressure at block 312, decreasing the temperature while under a high amount of isostatic pressure at 314, and decreasing pressure upon cooling at 316.

In some embodiments, the stacking a plurality of SPECTRA layers at 302 includes crosspliedly stacking 8 layers of unidirectional Honeywell SPECTRA 3124 developed by Allied Signal. In some embodiments, different materials are used and/or different relative amounts of the materials are used.

In some embodiments, the placing the stacked SPECTRA layers on the rigid backed support layer from 200 at 304 includes disposing the stacked SPECTRA layers directly on the rigid backed support layer from 200. In some embodiments, the stacked SPECTRA layers and the rigid backed support layer from 200 are disposed in a sealed vacuum bag that is capable of withstanding high temperatures (e.g., 600 F), the vacuum bag having a vacuum port. In certain embodiments, the vacuum bag is omitted.

In some embodiments, the inserting the stacked SPECTRA layers and rigid backed support layer into a hot isostatic press at 306 includes disposing the stacked SPECTRA layers and rigid backed support layer into a hot isostatic press as disclosed in U.S. Provisional Patent Application 61/068,964 and Ser. No. 12/401,582. Other presses are employable with method 300, including those that are not isostatic.

In some embodiments, the increasing the temperature under slight pressure at 310 includes increasing the temperature to approximately 250 F under approximately 200 PSI using a hot isostatic press as disclosed in U.S. Provisional Patent Application 61/068,964 and Ser. No. 12/401,582. In some embodiments, greater or less temperature and/or pressure are employed. In some embodiments, temperatures are increased to only to levels below the melting temperature of the polycarbonate within the rigid backed support layer from 200.

In some embodiments, the applying a vacuum source under slight pressure at 310 includes applying a vacuum source for approximately 5 minutes at approximately 250 F under approximately 200 PSI using a hot isostatic press as disclosed in U.S. Provisional Patent Application 61/068,964 and Ser. No. 12/401,582 to degas the stacked SPECTRA layers and rigid backed support layer. In some embodiments, the vacuum source is applied using the vacuum bag having a vacuum port.

In some embodiments, the applying a high amount of isostatic pressure at 312 includes applying omni-directional pressure of approximately 3500 PSI at approximately 250 F for approximately 10 minutes using a hot isostatic press as disclosed in U.S. Provisional Patent Application 61/068,964 and Ser. No. 12/401,582 to melt the thermoplastic of the stacked SPECTRA layers. In some embodiments, greater or less temperature, time, and/or pressure are employed. In some embodiments, non-omni-directional pressure is applied.

In some embodiments, the decreasing the temperature while under a high amount of isostatic pressure at 314 includes decreasing the temperature to approximately 100 F while under omni-directional pressure of approximately 3500 PSI to freeze the thermoplastic of the stacked SPECTRA layers in place. In some embodiments, the decreasing the temperature while under a high amount of isostatic pressure at 314 is accomplished by running cold water through cooling tubes for approximately 20 minutes until a temperature of approximately 100 F is reached while maintaining omni-directional pressure of approximately 3500 PSI.

In some embodiments, the decreasing pressure upon cooling at 316 includes reducing the pressure to establish the flexible core and rigid backed support layer.

In some embodiments, method 300 further includes providing a protective shell finishing for the flexible core and rigid backed support layer. In some embodiments, the protective shell finishing is composed of carbon fiber and KEVLAR in a polypropylene resin. However, the protective shell finishing may be constructed from any material referenced herein or other material to provide wear and tear protection or additional ballistic protection. For example, in some embodiments, the protective shell finishing can be composed of the same or different material present in the rigid backed support layer or the flexible core. In some embodiments, the protective shell finishing is omitted.

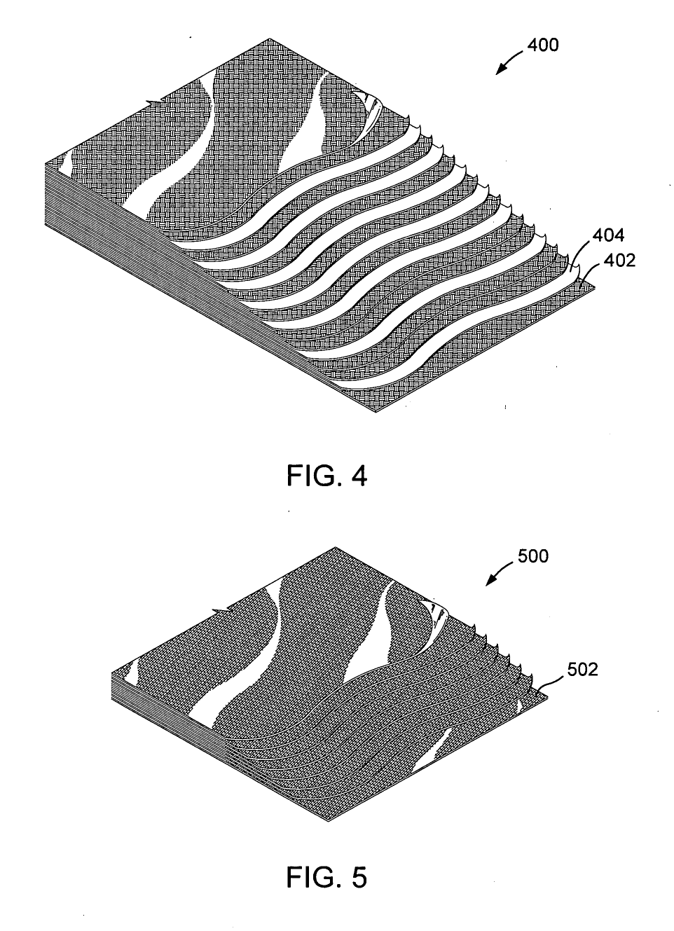

FIG. 4 illustrates layers for constructing a rigid backed support layer, in accordance with an embodiment of the invention. In some embodiments, layers for constructing a rigid backed support layer 400 include a plurality of fiber layers 402 and a plurality of thermoplastic layers 404. In some embodiments, 7 thermoplastic layers 404 are interposed between 11 stacked fiber layers 402. However, additional or fewer numbers of thermoplastic layers 404 and/or fiber layers 402 are employable. In some embodiments, the thermoplastic layers 404 are composed of polycarbonate and the fiber layers 402 are composed of KEVLAR. However, additional or different materials are employable as disclosed herein. In some embodiments, the layers for constructing a rigid backed support layer 400 are cut to a pattern, such as for a helmet, vest, shield, body armor, or other shape.

In some embodiments, the layers for constructing a rigid backed support layer 400 are cut to form tile sheets for later cutting to a pattern or using within vehicle, boat, plane, helicopter, walls, floors, ceilings, or other structure. In some embodiments, the layers for constructing a rigid backed support layer 400 arc large rollablc sheets. In some embodiments, the layers for constructing a rigid backed support layer 400 are used to establish a rigid backed support layer as described in methods 100 and/or 200.

FIG. 5 illustrates layers for constructing a flexible core, in accordance with an embodiment of the invention. In some embodiments, layers for constructing a flexible core 500 include a plurality of fibrous thermoplastic layers 502. In some embodiments, 8 fibrous thermoplastic layers 502 are stacked. However, additional or fewer numbers of fibrous thermoplastic layers 502 are employable. In some embodiments, the fibrous thermoplastic layers 502 are composed of unidirectional Honeywell SPECTRA 3124 and the fibrous thermoplastic layers 502 are crosspliedly stacked. However, additional or different materials are employable as disclosed herein. In some embodiments, layers for constructing a flexible core 500 are cut to a pattern, such as to match the pattern of the layers for constructing a rigid backed support layer 400 or for a helmet, vest, shield, body armor, or other shape.

In some embodiments, the layers for constructing a flexible core 500 are cut to form tile sheets for later cutting to a pattern or using within vehicle, boat, plane, helicopter, walls, floors, ceilings, or other structure. In some embodiments, the layers for constructing a flexible core 500 are large rollable sheets. In some embodiments, the layers for constructing a flexible core 500 are used to establish a flexible core as described in methods 100 and/or 300.

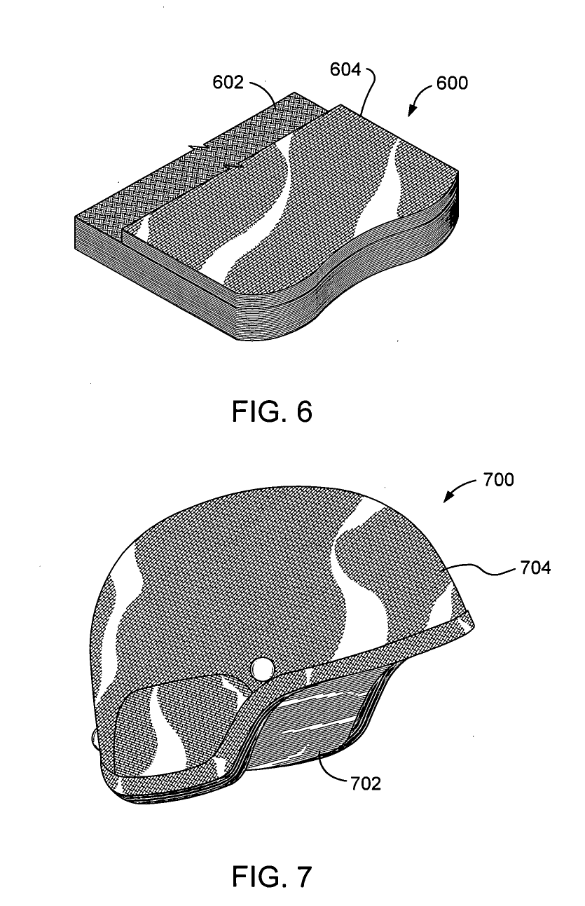

FIG. 6 illustrates a flexible core and a rigid backed support layer, in accordance with an embodiment of the invention. In some embodiments, the flexible core and rigid backed support layer 600 includes a rigid backed support layer 602 and a flexible core 604 constructed in accordance with methods 100, 200, and/or 300 disclosed herein to form armor. In some embodiments, the flexible core 604 is disposed above the rigid backed support layer 602 and is configured to serve as the impact layer during projectile impact. In some embodiments, the flexible core 604 is provided without the rigid backed support layer 602 and in other embodiments the rigid backed support layer 602 is provided without the flexible core 604.

In some embodiments, one or more additional flexible core 604 and/or rigid backed support layer 602 are provided above, below, or between the flexible core 604 and rigid backed support layer 602. In some embodiments, an additional protective shell finishing is provided around the flexible core and rigid backed support layer 600. In some embodiments, the flexible core and rigid backed support layer 600 are cut to a pattern, such as for a helmet, vest, shield, body armor, or other shape. In some embodiments, the flexible core and rigid backed support layer 600 are cut to form tile sheets for later cutting to a pattern or using within vehicle, boat, plane, helicopter, walls, floors, ceilings, or other structure.

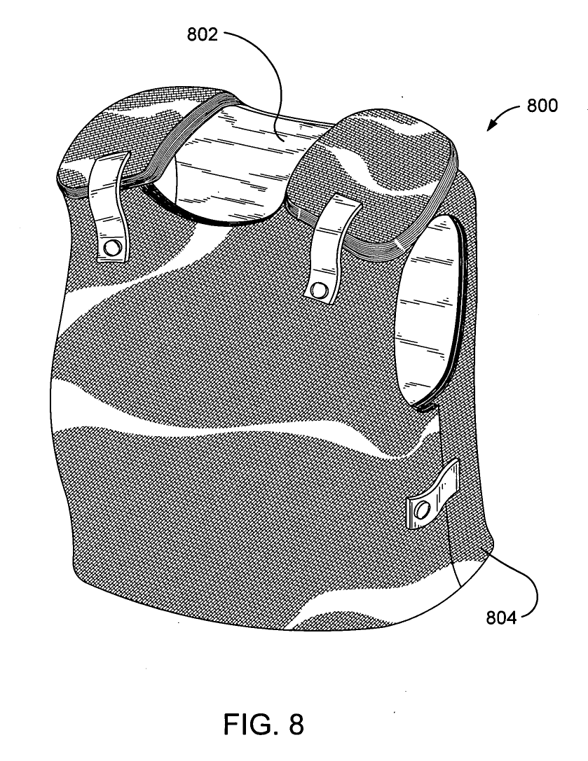

FIG. 7 illustrates a helmet constructed from a flexible core and a rigid backed support layer, in accordance with an embodiment of the invention. In some embodiments, the helmet 700 includes a rigid backed support layer 702 and a flexible core 704 constructed in accordance with methods 100, 200, and/or 300 disclosed herein.

FIG. 8 illustrates a vest constructed from a flexible core and a rigid backed support layer, in accordance with an embodiment of the invention. In some embodiments, the vest 800 includes a rigid backed support layer 802 and a flexible core 804 constructed in accordance with methods 100, 200, and/or 300 disclosed herein.

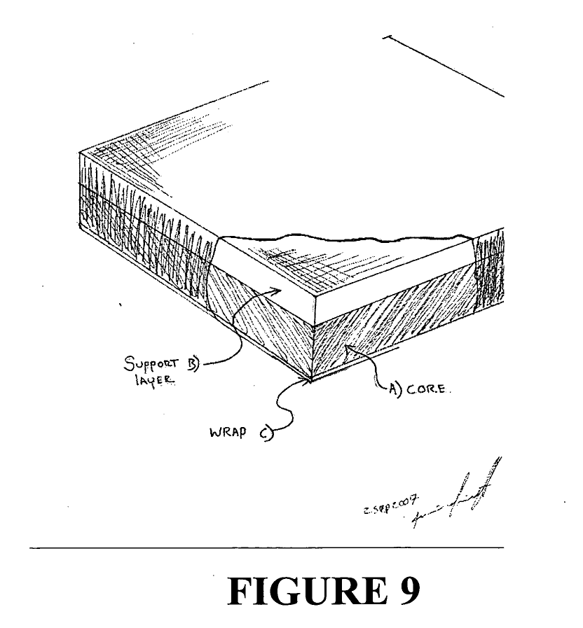

FIGS. 9 & 10 illustrate a flexible core 604 and a rigid backed support layer 602, with an optional wrap layer 606 to protect the composite from everyday wear and blunt impact. In these embodiments, an armor configuration is provided that reverses traditional armor configurations whereby a highly rigid composite material 602 is placed behind a flexible material 604 to establish armor that exhibits unique properties.

For example, in some embodiments, the flexible core 604 is composed of SPECTRA SHIELD 3124/3130/1600 or DSM Hb51/HB80/HB26 and the rigid backed support layer 602 is composed of KEVLAR 29 3000 denier 32×32 construction plain weave in a polyurethane or phenolic thermosetting resin having a durometer between approximately 50 and 90 Shore D based on an ASTM test for Shore D hardness. In some embodiments, the flexible core 604 is composed of SPECTRA SHIELD 3124/3130/1600 and the rigid backed support layer 602 is corn posed of KEVLAR 29 3000 denier 32×32 construction plain weave in a thermoplastic resin having a durometer between approximately 50 and 90 Shore D or having a Rockwell R hardness between approximately 80 and 150 based on an ASTM Rockwell R hardness test.

In some embodiments, the flexible core 604 is composed of SPECTRA SHIELD 3124 or DSM HB51 both unidirectional polyethylene fibers in a kraton rubber matrix and the rigid backed support layer 602 is composed of KEVLAR 29 3000 denier 32×32 construction plain weave in a thermoplastic resin having a durometer between approximately 50 and 90 Shore D or having a Rockwell R hardness between approximately 80 and 150. In some embodiments, the flexible core 604 is composed of SPECTRA SHIELD 3124/DSM HB51 kraton resin based unidirectional polyethylene fibers and the rigid backed support layer 602 is composed of DSM HB26 or HB80 polyurethane resin with a polyethylene unidirectional fiber reinforcement whereby the rigid polyurethane resin acts as the rigid layer to the softer kraton based resin system in the 3124/Hb51.

In some embodiments, the flexible core 604 is composed of SPECTRA SHIELD 3124/3130/1600 or HB26/HB51/HB80 or DSM DYNEEMA and the rigid backed support layer 602 is composed of KEVLAR 29/49 1000-3000 denier 17×17+38×38 construction with 50% carbon fiber plain weave or twill weave in a thermoplastic resin with a durometer between approximately 50 and 90 Shore D or having a Rockwell R hardness between approximately 80 and 150.

In some embodiments, the flexible core 604 is composed of SPECTRA SHIELD 3124/3130/1600 or HB26/HB51/HB80 or DSM DYNEEMA and the rigid backed support layer 602 is composed of KEVLAR 29/49 1000-3000 denier 17×17+38×38 construction with 50% carbon fiber plain weave or twill weave in a polyurethane or phenolic thermosetting resin with a durometer between approximately 50 and 90 Shore D or a Rockwell R hardness between approximately 80 and 150.

In some embodiments, the flexible core 604 and the rigid backed support layer 602 are defined by certain ballistic flexibilities and any material or composition of materials may be used to construct the flexible core 604 and the rigid backed support layer 602 so long as that material or composition of materials provides for the desired ballistic flexibility. As used herein, ballistic flexibility can be determined by backface deformation signatures resulting from ballistic impact and can be measured in mm of backface in heated clay.

Thus, a higher ballistic flexibility would result in higher backface deformations and a lower ballistic flexibility or increased ballistic rigidity would result in lower backface deformations. In one particular embodiment, the following steps can be used to determine ballistic flexibility. First, a bullet weight is chosen by NIJ standards in relation to Arial density. Second, a V50 or ballistic limit (BL) is established for the selected projectile in accordance with NIJ standards. Third, a 6″ by 6″ sample of material having a given Arial density (AD) is impacted at a set velocity by the selected projectile against a clay backing in accordance with NIJ standards. The velocity is derived from the NIJ standard for the threat level or from an industry standard of the velocity at the muzzle of the firearm designed to fire the selected projectile. Fourth, backface deformation is measured in millimeters (A). Fifth, a 12″ by 12″ sample of the material having the same AD is impacted at the same velocity 6 times at 4″ intervals against a clay backing in accordance with NIJ standards. Sixth, backface deformation is measured in millimeters for each impact and the mean number is determined (B). Seventh, A and B are added to establish C and BL/C @ AD is determined. In one particular embodiment, the flexible core 604 is any material or composition of materials ranging from 1600/144/1.2AD to 1600/600/1.2D and the rigid backed support layer 602 is any material or composition of materials ranging from 1100/20/1.2AD to 1100/90/1.2AD.

However, it should be clear that these ranges may be different or scaled up for various threat levels. Thus, in some embodiments, the rigid backed support layer 602 is any material or composition of materials having a low C for a given BL and the flexible core 604 is any material or composition of materials having a relatively higher C for a given BL. In some embodiments, the rigid backed support layer 602 and/or the flexible core 604 are composed of one or more thermosetting, thermocuring, ultra-violet curing, or thermoplastic resins having one or more fiber reinforcements. It is also possible to use only thermoplastics, only fibers, or even different materials such as metals such as titanium, aluminum, or even fiber reinforced metals. Thus, in some embodiments, the rigid backed support layer 602 and/or the flexible core 604 may be composed of similar or different materials.

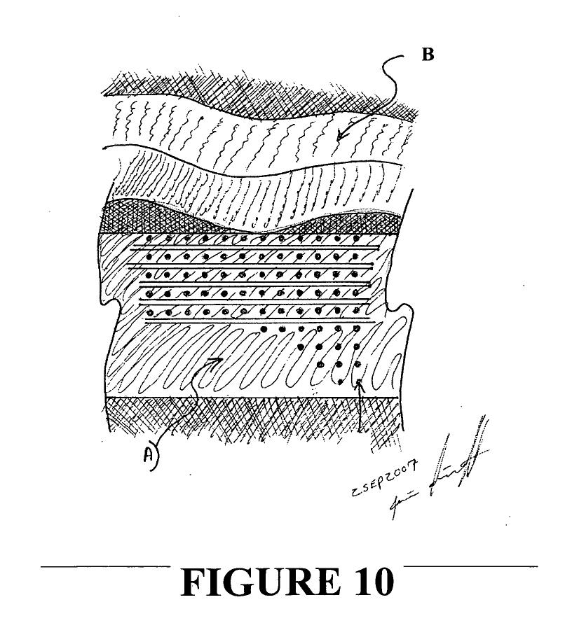

FIG. 10 illustrates alternate support layer 602 and flexible core 604 arrangement. It also illustrates a schematic detail of support layer matrix material 601 (dots representing fibers going into the page, hollow lines representing fibers in the plane of the page). In this alternate embodiment, soft core material 604 is relatively more flexible, and is preferably not compressed.

Examples of thermosetting, thermoplastic, thermocuring, or ultra-violet curing resins include polyurethane, epoxy, polyester, rubber, or other similar material including thermo. Examples of fibers include unidirectional, woven, loose woven, differently aligned, or a combination of the foregoing aramid, carbon, Zylon, PBO, polyethylene, polypropylene, ceramic such as boron carbide, alumina oxide, or silicon carbide, liquid crystal polymer based, glass based, or other similar material. Other materials employable as thermosetting or thermoplastic resins or fibers include those present in SPECTRA SHIELD, DYNEEMA, GOLD SHIELD, U.S. Pat. No. 5,443,882, U.S. Pat. No. 5,330,820, U.S. Pat. No. 7,148,162, U.S. Pat. No. 7,073,538, U.S. Pat. No. 5,135,804, U.S. Pat. No. 4,853,427 all of which are hereby incorporated by reference in their entirety as if fully set forth herein. In some embodiments, a protective shell finishing is provided that may the same or different material from those listed herein.

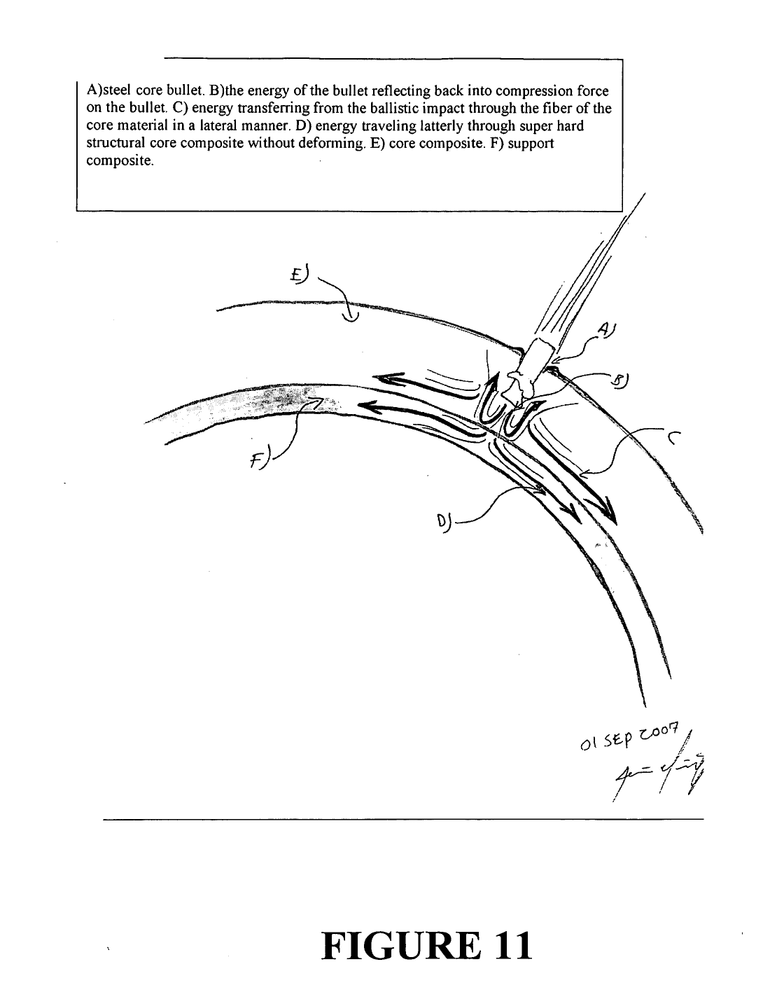

FIGS. 11-13 illustrate particular ballistic performance characteristics of preferred armor composite embodiments. In FIG. 11 steel core bullet 7 impacts and enters core composite layer 604. Part of the bullet energy (arrows 9) is believed to reflect back into a kind of compression force on bullet 7, causing its jacket to peel and mushroom. While another part of the bullet energy (arrows 15) is believed to transfer through the fiber of core 604 material in a lateral manner. As bullet 7 completes its penetration of core 604, and strikes relatively rigid support layer 602, bullet energy (arrows 17) is believed to travel laterally through support layer 602 with relatively little or no deformation of the layer 602.

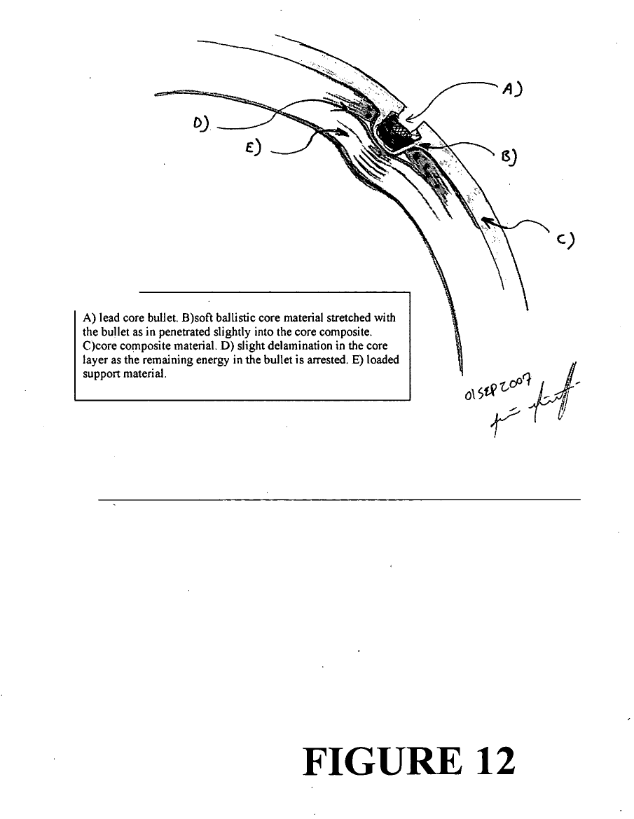

In FIG. 12 lead core bullet 8 impacts and enters relatively soft ballistic core material 604, which is stretched (see generally at 12) by the bullet as it penetrates slightly into core 604. Support layer 602 is slightly deformed and delaminated (see generally at 14) as the remaining energy of bullet 8 is arrested.

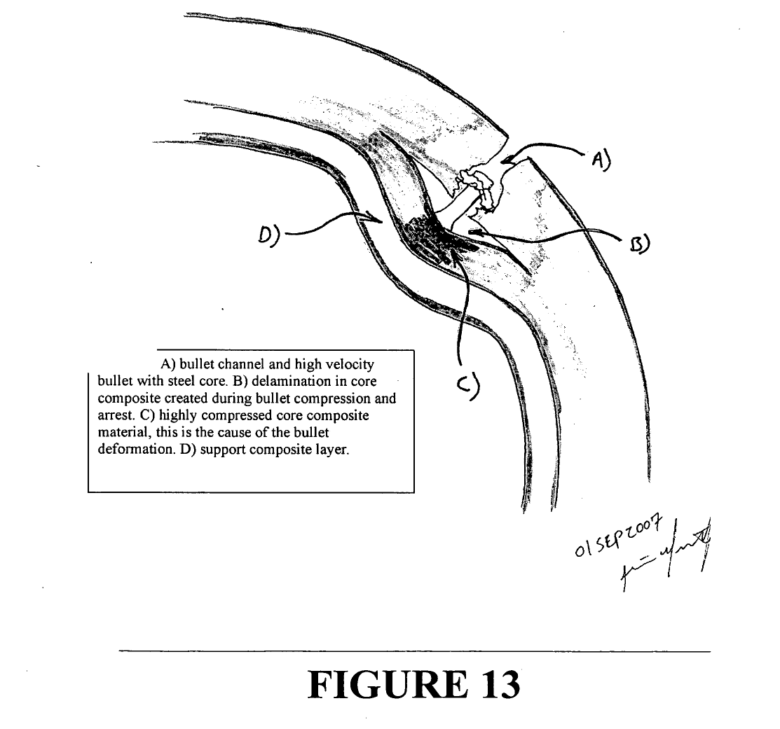

In FIG. 13 high velocity steel core bullet 5 impacts and enters core composite layer 604, leaving bullet channel 6, with delamination (see generally at 16) in core 604 and highly compressed core composite material (see generally at 18), both created during bullet compression and arrest, resulting in generally illustrated severe bullet deformation, and some support layer 602 deformation as well.

While preferred and alternate embodiments of the invention have been illustrated and described, as noted above, many changes can be made without departing from the spirit and scope of the invention. For example, varying levels of ballistic protection can be achieved by adding or subtracting layers of material, or by varying the temperature, pressure, and time variables in the process. Each variable can have an impact on ballistics, cost, weight, and production capacity depending on the need of the manufacturer. Accordingly, the scope of the invention is not limited by the disclosure of these preferred and alternate embodiments. Instead, the invention should be determined entirely by reference to the claims that follow.

1-35. (canceled)

36. An armor composite article comprising:
a relatively less ballistically rigid composite front armor layer disposed upon
a relatively more ballistically rigid composite back armor layer;
wherein the front layer is disposed in the article to face an oncoming projectile and to receive first impact of the projectile before the back layer receives impact; and
wherein relative rigidity of the layers is defined in ballistic terms according to well known standards.

37. The article of claim 36, wherein relative rigidity is expressed in terms of relative backface deformation C in mm for a given BL, such that relatively lower C is exemplary of more rigid layers, and relatively higher C is exemplary of relatively less rigid layers.

38. The article of claim 37, wherein less rigid layers have BL/C values in the range of 144 to 600 and more rigid layers have BL/C values in the range of 20 to 90.

39. The article of claim 36, the front layer further comprised of a plurality of layers of a material selected from the group of materials consisting of SPECTRA SHIELD 3124/3130/1600, DSM HB51/HB80/HB26, and DSM DYNEEMA, the layers then pressed in a HIP, and cooled while still under pressure.

40. The article of claim 36, the back layer further comprised of a plurality of layers of a material selected from the group of materials consisting of KEVLAR 29 3000 denier 32×32 construction plain weave, KEVLAR 29/49 1000-3000 denier 17×17+38×38 construction with 50% carbon fiber plain weave, and KEVLAR 29/49 1000-3000 denier 17×17+38×38 construction with 50% carbon fiber twill weave, the material in a thermoplastic resin, the layers then pressed in a HIP, and cooled while still under pressure.

41. The article of claim 36, the back layer further comprised of a plurality of layers of a material selected from the group of materials consisting of rigid DSM HB26 and HB80 polyurethane resin each with a polyethylene unidirectional fiber reinforcement, the layers then pressed in a HIP, and cooled while still under pressure.

42. The article of claim 39, where the selected material is SPECTRA SHIELD 3124 or DSM HB51 and the materials further comprise unidirectional polyethylene fibers in a kraton rubber matrix.

43. The article of claim 40, where the thermoplastic resin is a polyurethane or phenolic thermosetting resin.

44. The article of claim 40, where the back layer has a durometer approximately 50 to 90 Shore D or a Rockwell hardness approximately 80 R to 150 R, after pressing and cooling:

45. The article of claim 39, where the plurality of layers are unidirectional SPECTRA SHIELD 3124 that are crosspliedly stacked with respect to one another.

46. The article of claim 36, further comprising a protective layer covering at least a portion of the front layer.

47. The article of claim 36, further comprising at least one piece of an armor layer that is cut to fit at least a portion of a human anatomy.

48. The article of claim 36, the front armor layer further comprising an outer layer comprised of an outer armor layer that is relatively more ballistically rigid than the rest of the front layer, and also relatively less ballistically rigid than the back layer; where the outer layer is the layer that is disposed in the article to face an oncoming projectile and to receive first impact of the projectile.

49. An armor composite article comprising:
a relatively less ballistically rigid composite front armor layer disposed upon a relatively more ballistically rigid composite back armor layer;
wherein the front layer is disposed in the article to face an oncoming projectile and to receive first impact of the projectile before the back layer receives impact; and
wherein relative rigidity is expressed in terms of relative backface deformation C in mm for a given BL, such that relatively lower C is exemplary of more rigid layers, and relatively higher C is exemplary of relatively less rigid layers.

50. The article of claim 49, wherein less rigid layers have BL/C values in the range of 144 to 600 and more rigid layers have BL/C values in the range of 20 to 90.

51. An armor composite article comprising:
a relatively less ballistically rigid composite front armor layer disposed upon a relatively more ballistically rigid composite back armor layer;
the front layer further comprised of a plurality of layers of a material selected from the group of materials consisting of SPECTRA SHIELD 3124/3130/1600, DSM HB51/HB80/HB26, and DSM DYNEEMA, the layers then pressed in a HIP, and cooled while still under pressure;
the back layer further comprised of a plurality of layers of a material selected from the group of materials consisting of KEVLAR 29 3000 dether 32×32 construction plain weave, KEVLAR 29/49 1000-3000 denier 17×17+38×38 construction with 50% carbon fiber plain weave, and KEVLAR 29/49 1000-3000 denier 17×17+38×38 construction with 50% carbon fiber twill weave, the material in a thermoplastic resin, the layers then pressed in a HIP, and cooled while still under pressure;
wherein the front layer is disposed in the article to face an oncoming projectile and to receive first impact of the projectile before the back layer receives impact; and
wherein relative rigidity of the layers is defined in ballistic terms according to well known standards.

52. The article of claim 51, where the selected material for the front layer is SPECTRA SHIELD 3124 or DSM HB51 and the materials further comprise unidirectional polyethylene fibers in a kraton rubber matrix.

53. The article of claim 51, where the thermoplastic resin is a polyurethane or phenolic thermosetting resin.

54. The article of claim 51, where at least a portion of the plurality of layers are crosspliedly stacked with respect to one another.
